(19) United States
(12) Patent Application Publication
(10) Pub. No.: US 2008/0215369 A1
(43) Pub. Date: Sep. 4, 2008

(54) METHOD AND SYSTEM FOR AUTOMATICALLY GENERATING FORMS

(75) Inventor: David Lareau, Oakton, VA (US)

Correspondence Address: BUCHANAN, INGERSOLL & ROONEY PC, POST OFFICE BOX 1404, ALEXANDRIA, VA, 22313-1404, US

(73) Assignee: MEDICOMP SYSTEMS, INC., Chantilly, VA (US)

(21) Appl. No.: 12/033,596

(22) Filed: Feb. 19, 2008

Related U.S. Application Data
(60) Provisional application No. 60/901,684, filed on Feb. 16, 2007.

(51) Int. Cl. G06F 19/00

(52) U.S. Cl. 705/3

(57) ABSTRACT

Selected data from a hierarchical database, such as medical findings of symptoms, physical findings, etc., can be used to generate a form dynamically. A system for generating forms based on a hierarchy of data received from a patient includes an input device for entering data received from a patient into a processor and a web browser. The web browser is configured for generating a form populated with the data entered using the input device. The placement of the data on the form is based on the hierarchy of the data received from the patient. The system also includes a network connection for receiving and transmitting data and the generated form via the web browser or an electronic mail application, a memory for storing data and forms generated by the web browser and an output device for outputting the generated form or received data.

### CROSS-REFERENCE TO RELATED APPLICATIONS

This application claims priority from U.S. Provisional Patent Application Ser. No. 60/901,684, filed Feb. 16, 2007, the disclosure of which is hereby incorporated by reference in its entirety.

### BACKGROUND

1. Field

The subject matter presented herein relates generally to automatic form generation, and more particularly, to forms populated with data entered into a medical database, wherein the generated form has the necessary format used by entities requiring use of the form.

2. Description of Related Art

For centuries, medical information has been recorded on forms. A standard procedure has evolved whereby a doctor records in a patient's chart, first, the history of the present illness, then, other symptoms, followed by the physical examination, and the ordering of various tests. Using the information obtained from the physical examination and testing, one or more diagnoses and a treatment plan are formulated. For any particular patient, the doctor's notes entered into the medical record are based on the nature of the patient's problem. Typically, all chart entries have to be made on a fixed set of forms. When medical recordkeeping moved from paper to computers, the same approach of having a fixed set of forms was continued.

### SUMMARY

In one embodiment, a method is disclosed for generating a form based on a hierarchy of data received from a patient, including the steps of entering data received from a patient into a processor via an input device; generating a form populated with the entered data, wherein the placement of the data on the form is based on a hierarchy of the data received from the patient; receiving and transmitting data and generated form via a web browser or an electronic mail application using a network connection; storing data and forms generated by the web browser; and outputting the generated form or received data.

In another embodiment, a system is disclosed for generating forms based on a hierarchy of data received from a patient, including an input device for entering data received from a patient into a processor; a web browser, wherein the web browser is configured to generate a form populated with the data entered using the input device, wherein the placement of the data on the form is based on the hierarchy of the data received from the patient; a network connection for receiving and transmitting data and generated form via the web browser or an electronic mail application; a memory for storing data and forms generated by the web browser; and an output device for outputting the generated form or received data.

In another embodiment, a computer-readable medium containing instructions for causing a computer to execute a method of generating forms based on a hierarchy of data received from a patient is disclosed. The method includes entering data received from a patient into a processor via an input device; generating a form populated with the entered data, wherein the placement of the data on the form is based on a hierarchy of the data received from the patient; receiving and transmitting the data and generated form via a web browser or an electronic mail application using a network connection; storing the data and generated form; and outputting the generated form or received data.

### BRIEF DESCRIPTION OF THE DRAWINGS

As will be realized, different embodiments are possible, and the details herein are capable of modification in various respects, all without departing from the scope of the claims. Accordingly, the drawings and descriptions are to be regarded as illustrative in nature and not as restrictive.

FIG. 1 is an exemplary display of items for documentation during a Prenatal Exam;

FIG. 2 is an exemplary display of items for documentation of the management of a patient with hypertension;

FIG. 3 shows both boxes having been checked which the merged findings from the OB Exam and the Dx Prompt for hypertension;

FIGS. 4 and 5 show the exemplary result of alternately clicking in the left column on the text of OB exam and Dx Prompt;

FIG. 6 shows the exemplary result of clicking on Auto Forms with both the OB Exam and Hypertension selected;

FIG. 7 illustrates an exemplary function of the Auto Forms where the source of the data is shown;

FIG. 8 illustrates that the exemplary List Size is preserved;

FIG. 9 shows the dynamic addition of the exemplary Hypertension findings;

FIG. 10 shows the exemplary hypertension findings that were added in FIG. 9;

FIGS. 11-14 illustrate an exemplary progression of outputs to a user as a result of exemplary inputs by a user;

FIG. 15 illustrates an expanded display of data elements according to an exemplary embodiment;

FIG. 16 illustrates an exemplary view of a data element expanded within a frame;

FIG. 17 illustrates an exemplary expanded view of parent and child data elements using an attribute method in an expanded frame view;

FIG. 18 illustrates another exemplary view of a data element expanded within a frame;

FIG. 19 illustrates another exemplary expanded view of parent and child data elements in an expanded frame view;

FIG. 20 illustrates a further expansion of the expanded frame view using a division method to the bottom level of the hierarchical database;

FIG. 21 illustrates an exemplary system for implementing an embodiment of the above described method.

### DETAILED DESCRIPTION

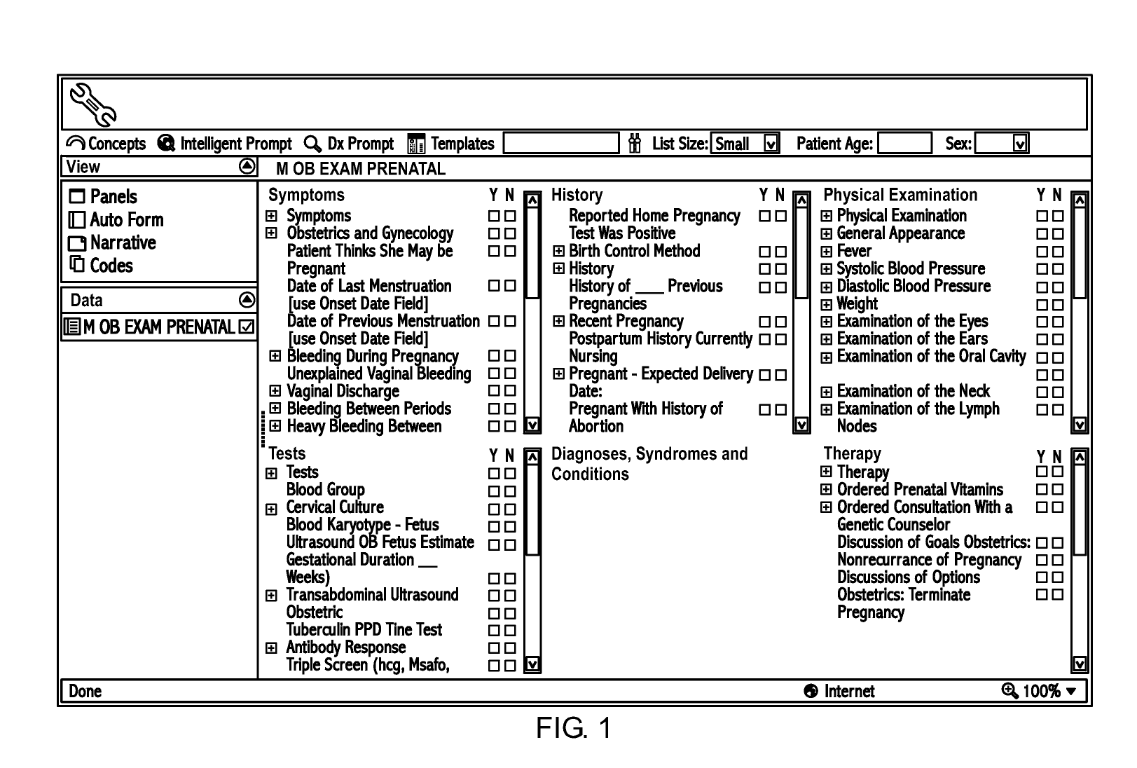

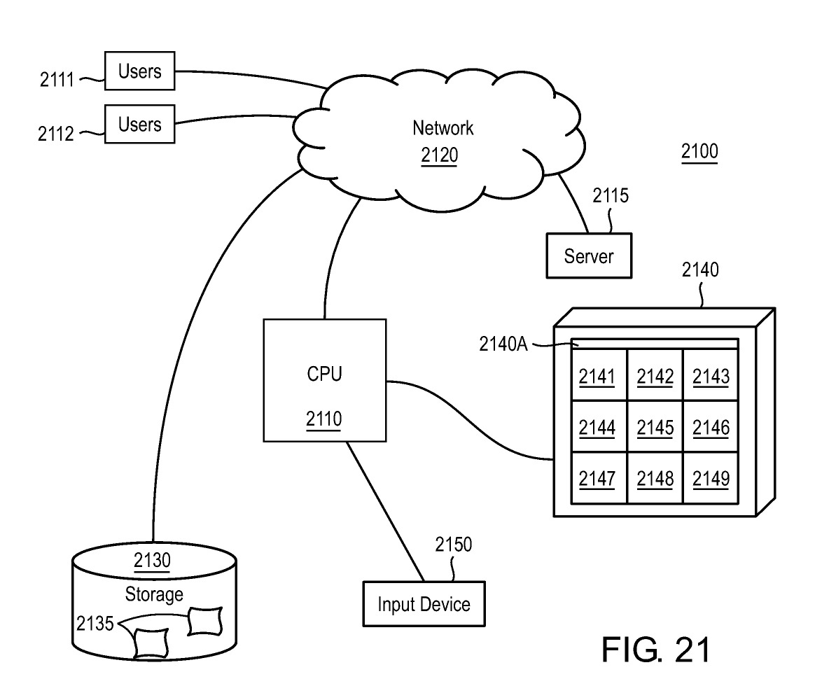

FIG. 1 shows an exemplary display of items for documentation during a prenatal exam of a patient. In an exemplary method of generating forms based on a hierarchy of data received from a patient, a user, for example a physician or patient, can enter data received from a patient into a processor via an input device, such as a mouse, stylus, voice command, or similar device. (Note that FIG. 21 and the accompanying discussion below illustrate an exemplary system for implementing an embodiment of the exemplary method.)

In the display in FIG. 1, there can be medical concepts grouped into frames containing, for example, six data types. The categories can be structured as follows: in Symptoms, the patient's complaints can be grouped by body system; History can be by type; Physical Exam can be anatomical; Tests can be by type; Diagnoses, Syndromes and Conditions can be by specialty and Therapy can be by type and provider. Each category can be configured to contain sufficient context to make it clinically meaningful. Of course, the categories can be structured however a user desires to present the information or considers it to be most intuitive.

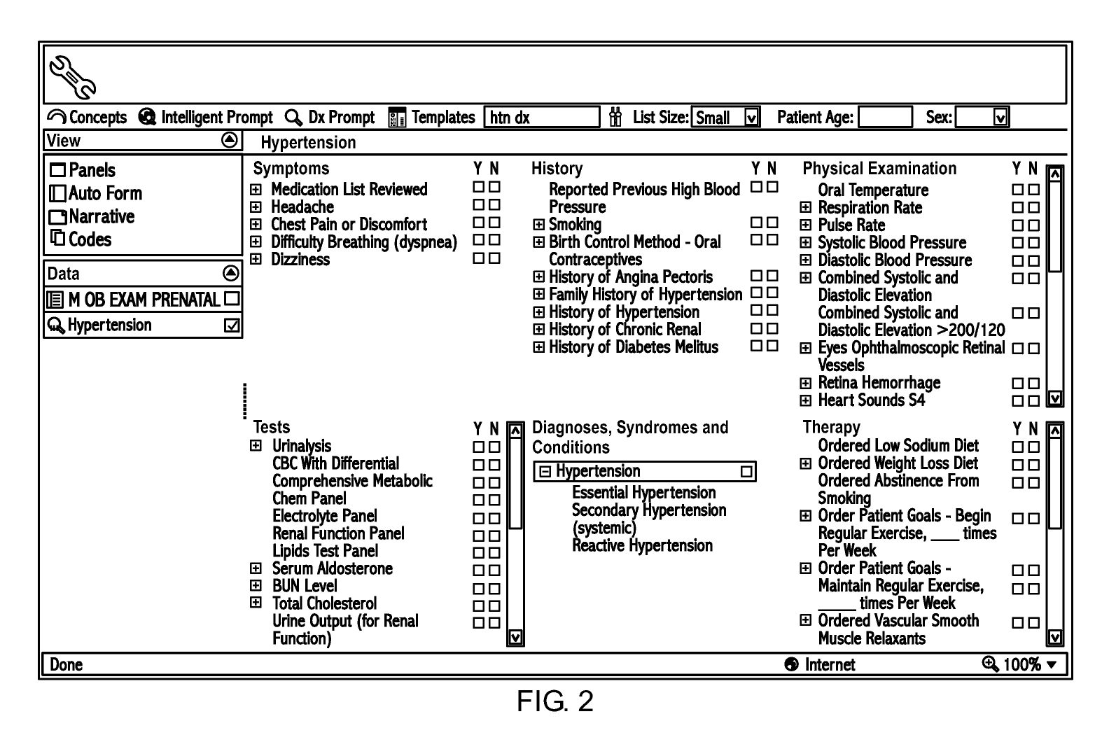

FIG. 2 is an exemplary display of items for documentation for the management of a patient with Hypertension. This can be displayed by a user selecting Hypertension and clicking with a user input device the Dx Prompt option on the toolbar.

Still referring to FIG. 2, in the column on the left, under the Data menu, the listings M OB Exam Prenatal and Hypertension are shown, with the latter having a checkmark next to it to indicate that is the data currently being displayed. Note under Diagnoses, Syndromes and Conditions, Hypertension is highlighted with, in this example, a rectangular box. Of course, the indication is not limited to a checkmark, but could be background highlighting, change in text color, filled-in circles or some other indicator. Similarly, the highlighting of Hypertension could also be done by the use of color or some other indicator.

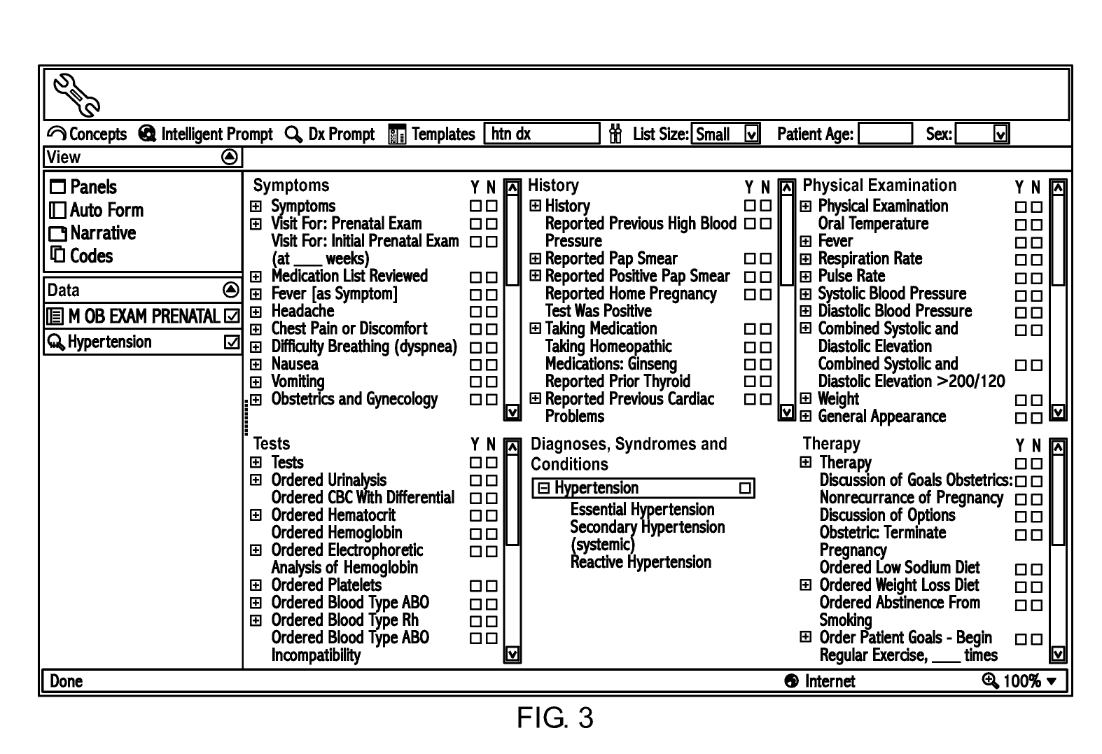

FIG. 3 shows both boxes under the Data menu having been checked. In this example, this action merges the findings from the OB Exam and the Dx Prompt for Hypertension.

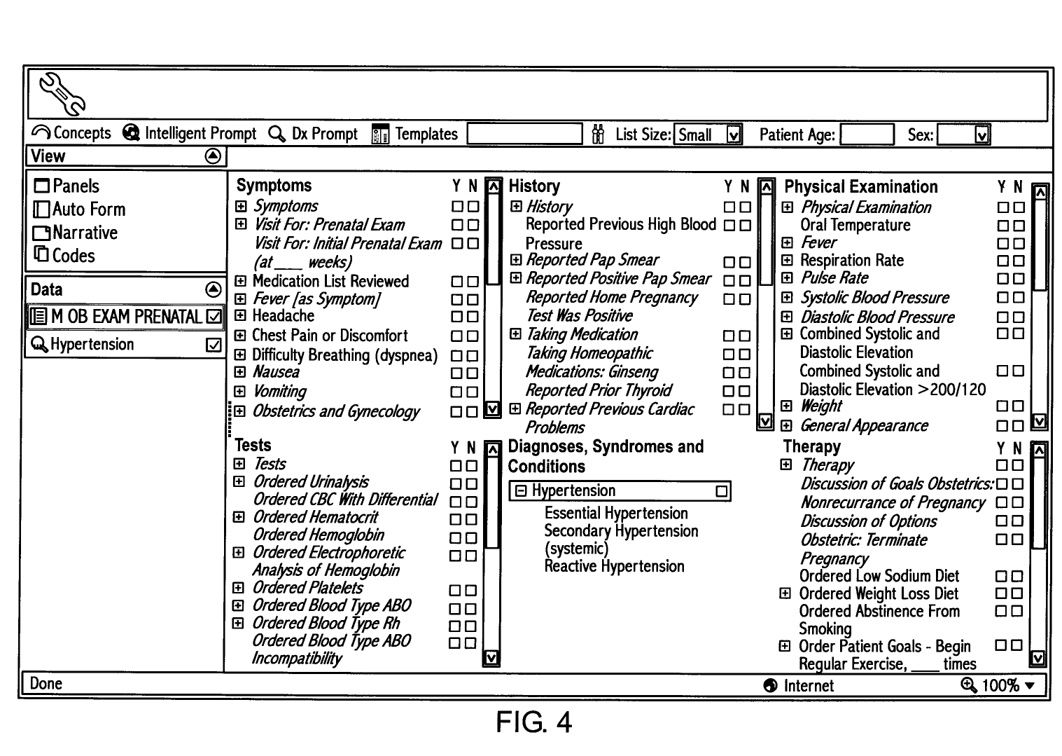

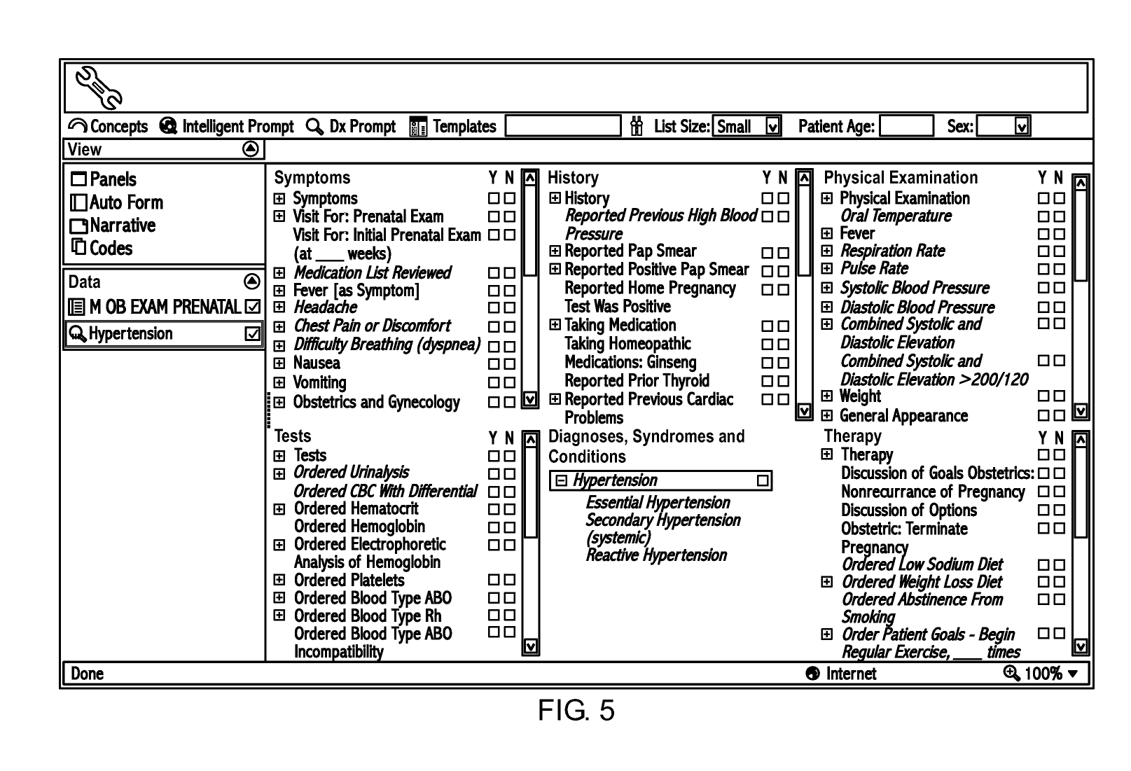

FIGS. 4 and 5 show an example of the result of alternately clicking on the text of M OB Exam Prenatal and Dx Prompt, respectively, in the Data menu in the left column. Some of the text in the center frames turns to highlighted text, which in this example is bold italics. Of course, highlighting could be carried out in any suitable way, for example by changing the text color to red. The highlighted text can be the data that originated from whichever item in the Data menu that was last clicked. Thus, even though it is merged, a user can still tell its origins. In addition, the origin field under the Data menu can be highlighted, in this case in a rectangle, to also show the origin. Again, such highlighting can be carried out in any suitable way. Many findings in the frames can remain highlighted as the user alternates between selecting the text of M OB Exam Prenatal and Dx Prompt because the findings occur in both the OB Exam and the Dx Prompt in Hypertension. Of course, the highlighting can be by any way of drawing attention to a particular piece of information, such as by a suitable color, or can be by highlighting or some other form of indication, or an audio indicator. In addition, the item which is the origin of the data field under the Data menu does not have to be highlighted.

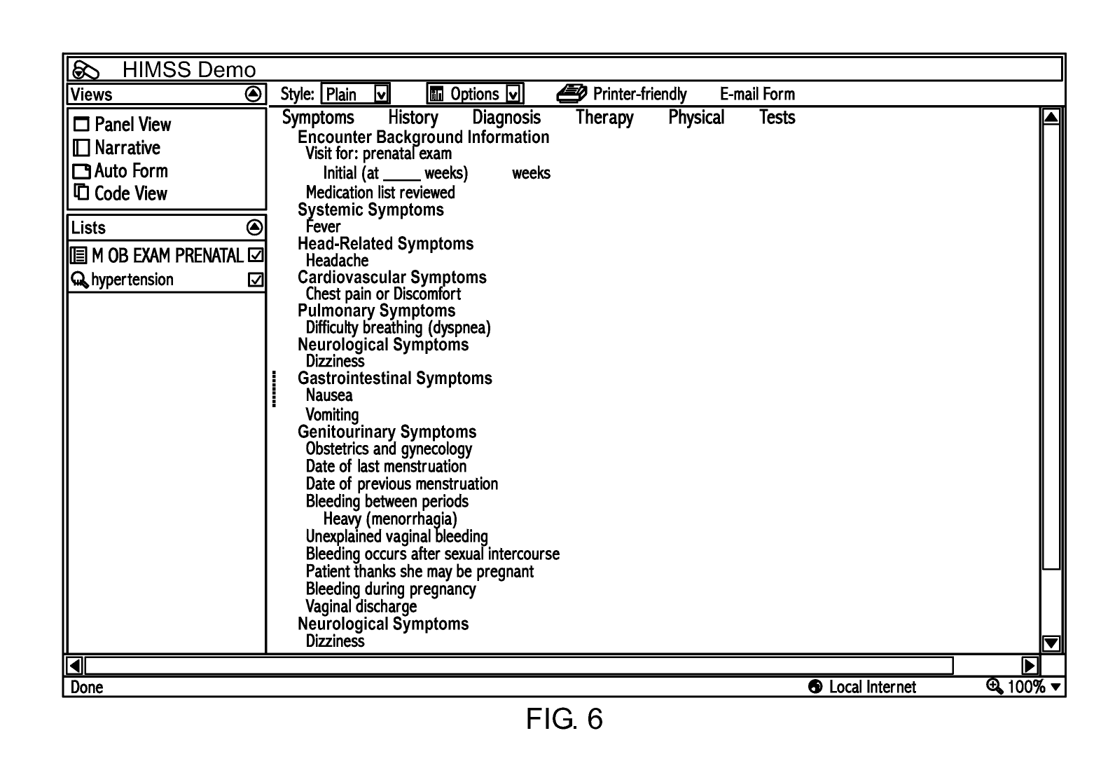

FIG. 6 shows an example of the result of selecting, by using a user input device, Auto Form (column on left) under the Views menu with both the OB Exam and Hypertension selected (checked boxes). Using the input device, an Auto Form can be generated populated with the entered data, wherein the placement of the data on the form is based on a hierarchy of the data received from the patient. For simplicity, only the symptoms are being shown. However, the results and findings from the other categories can be shown by selecting one of the tabs: History, Diagnosis, Therapy, Physical, or Tests in this example.

The findings can be received and transmitted, as can the generated form, via a web browser or an electronic mail application using a network connection. In addition, the data and forms generated by the web browser can be stored in memory in a database or other storage location. The generated form or received data can be outputted to a user such as a patient, physician, insurance provider or other person by, for example, a facsimile device, display device, printer or other type of output device.

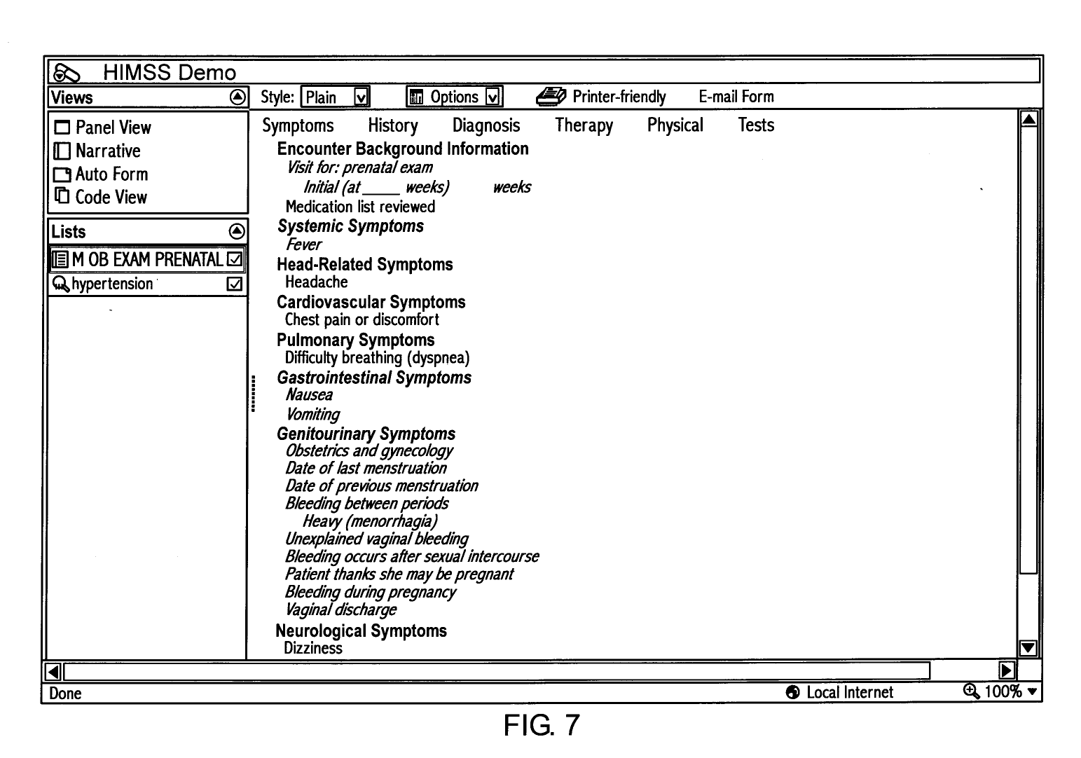

FIG. 7 shows an example that in the Auto Form view, the knowledge of the origin of the data has been retained. Here, the OB Exam findings are highlighted in bold italics. Any suitable way of highlighting may be used.

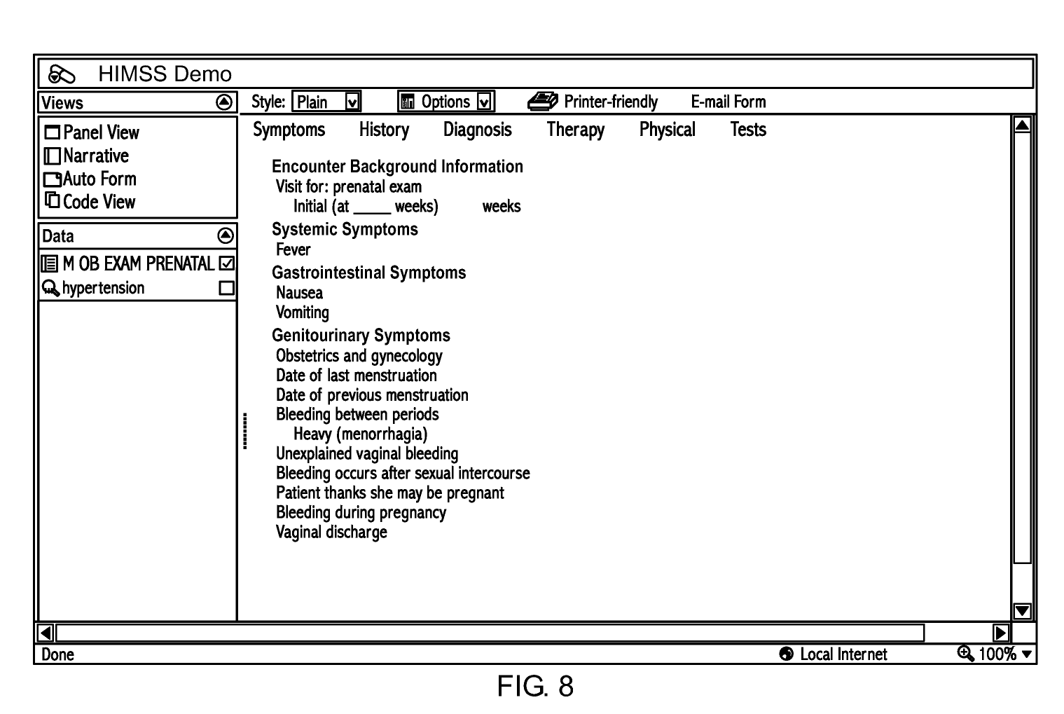

FIG. 8 shows an example that knowledge of the List Size is preserved. Here, the list size, as shown on the tool bar of FIG. 5, has been reduced from Medium to Small and the findings coded as “most important” remain in the form. List size can be the number of findings that are presented to a user. The Small list size, for example, presents to the user those findings that are more commonly found based on the user inputs into different categories, such as Symptoms. Based on the selected Symptoms, some Diagnoses will be eliminated from the Small List and/or the Medium list. The Small list size can, for example, present data findings that are most common based on the information input; the Medium list size can present finds that are common; and the Large list size can present all of the findings, or some combination thereof. That is, the form has been dynamically reduced in detail for minimal documentation needs. Conversely, the list size can be resized upwards from Small to Large, with the related increase in the amount of data presented in the form, to include more detail, if desired.

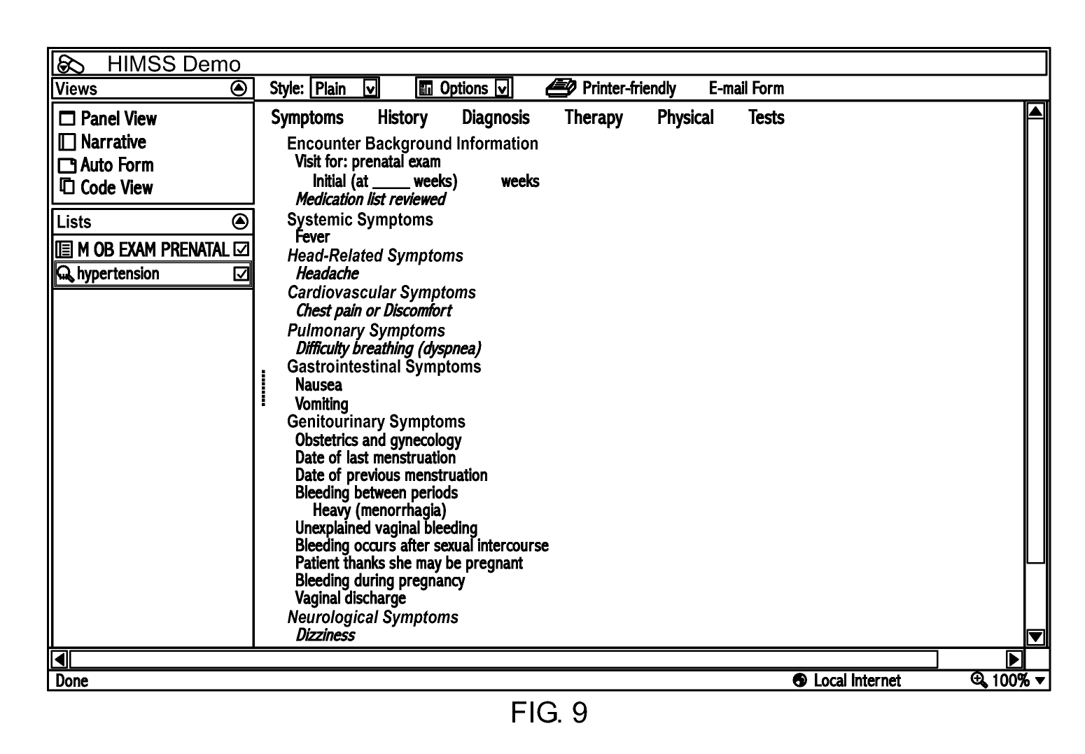

FIG. 9 shows the addition of the Hypertension findings, dynamically, and the highlighting to show which findings are associated with the Hypertension diagnosis. The findings associated with Hypertension diagnoses are shown in bold italics in this example and include, for example, Medication List Reviewed under Encounter Background Information heading, Head-Related Symptoms, Cardiovascular symptoms, and so on.

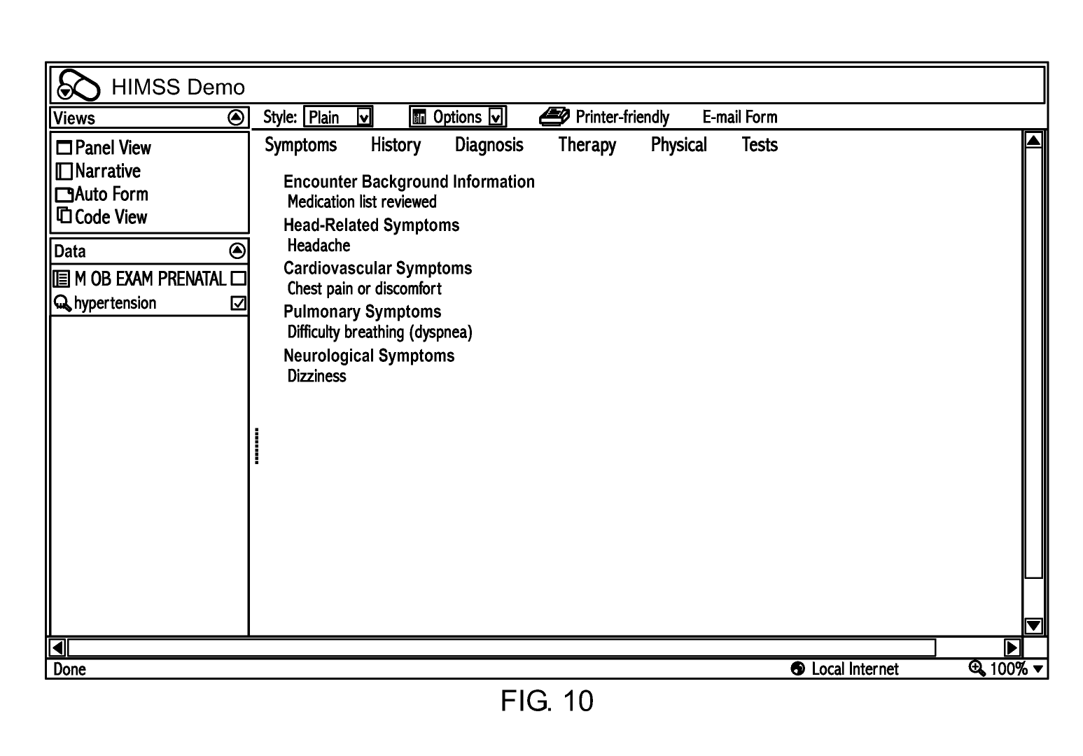

FIG. 10 shows an example of the hypertension findings that were added in FIG. 9. In this example, since Hypertension is checked in the Lists menu, items associated with Hypertension appear.

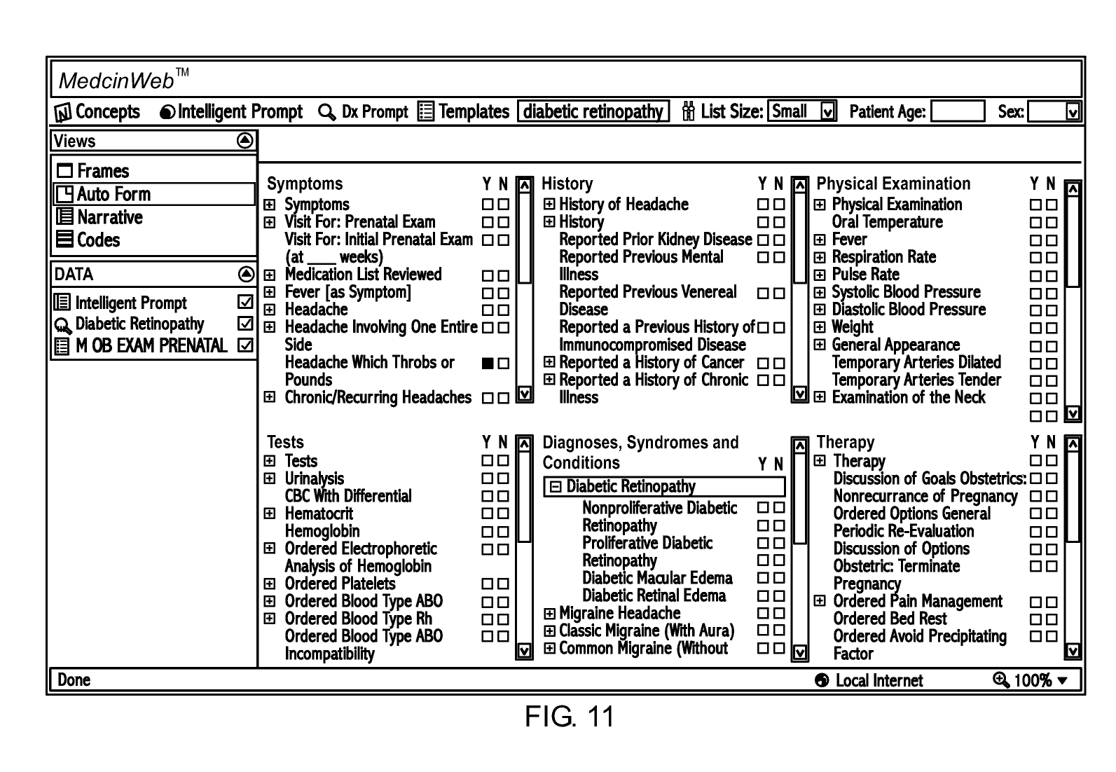

FIGS. 11-14 illustrate an exemplary process of generating an Auto Form. Referring to FIG. 11, to generate a form using new data that a user has entered up to this point, the user can click using an input device, such as a mouse, stylus, voice command, or the like, on ‘Auto Form’ under the Views menu in the left column. Note also in this example that the symptom “Headache Which Throbs or Pounds” has been checked “Yes.”

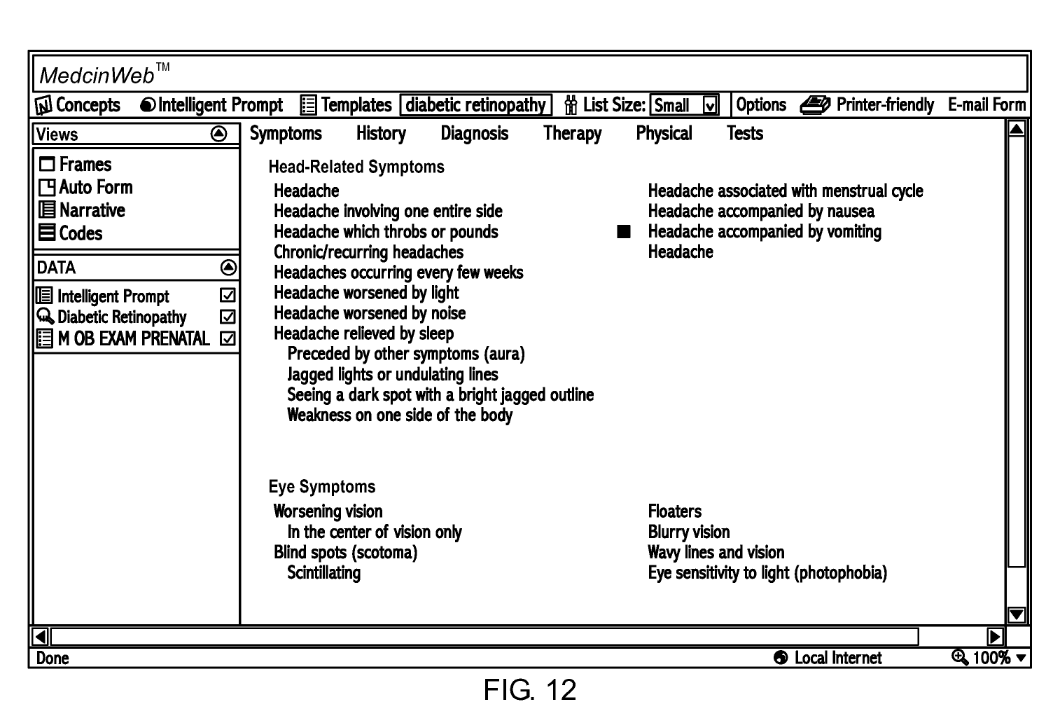

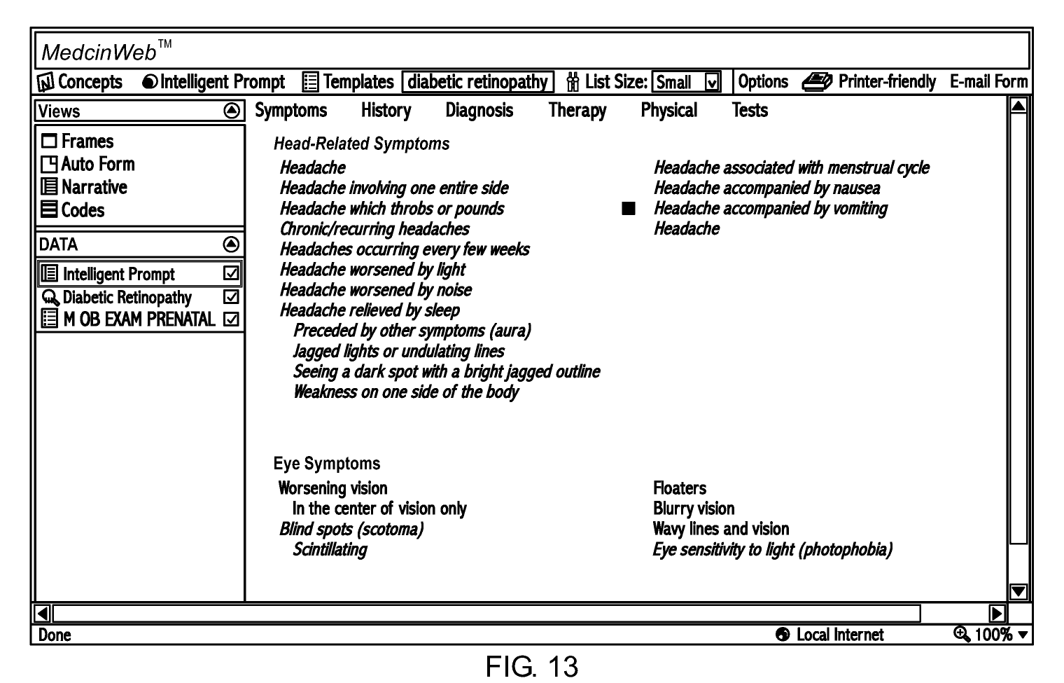

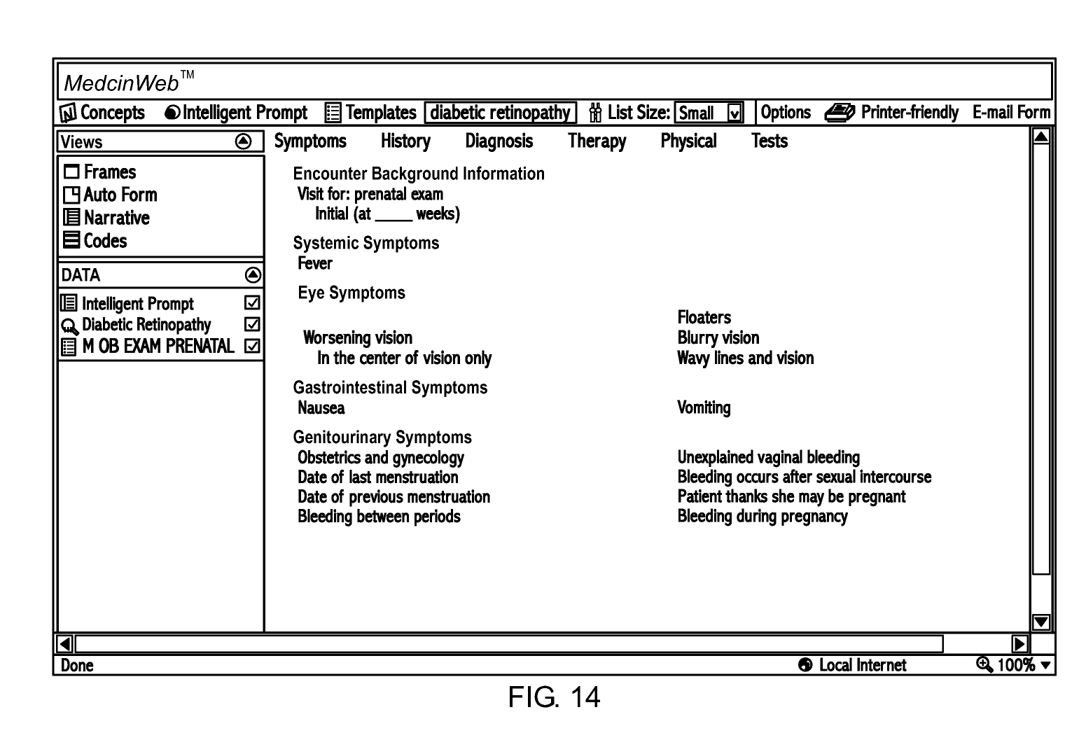

FIG. 12 illustrates an example of the merged categories ordered into a tabular form. Of course, other organizational schemes can be used. In FIG. 12, the Symptoms tab will be explained, but the other tabs illustrate similar results for the respective findings underneath those categories. By clicking on the text for Intelligent Prompt under the Data menu, the categories originating from the Intelligent Prompt can be highlighted, in bold italics, as shown in FIG. 13. Again, the use of colors or other suitable highlighting can be used. If, in this example, the user is not going to be investigating the Headache, the user can contract or reduce the data in the form by un-checking the Intelligent Prompt box, as shown in FIG. 14. Note that the findings previously highlighted are no longer part of the Auto Form.

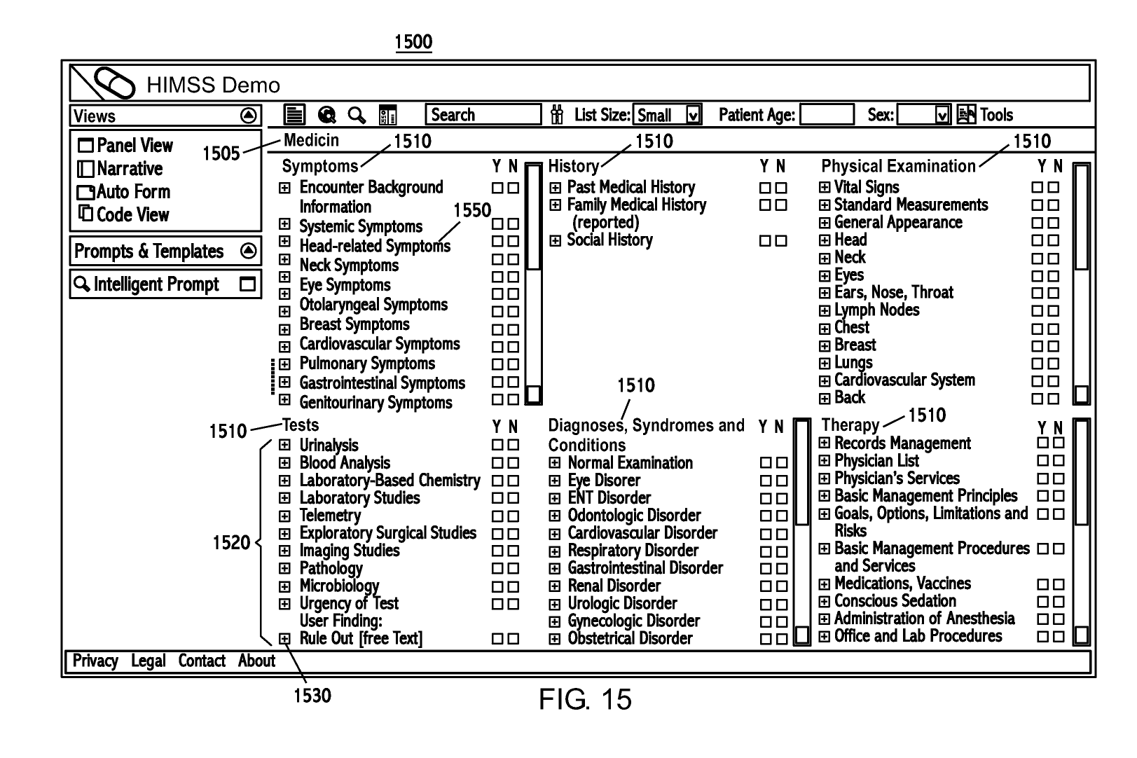

FIG. 15 illustrates an example of an expanded display 1500 of the data elements 1510 under the main data element 1505. Main data element 1505 can be any data element that has parent data elements 1510 beneath it in the hierarchical data structure or database.

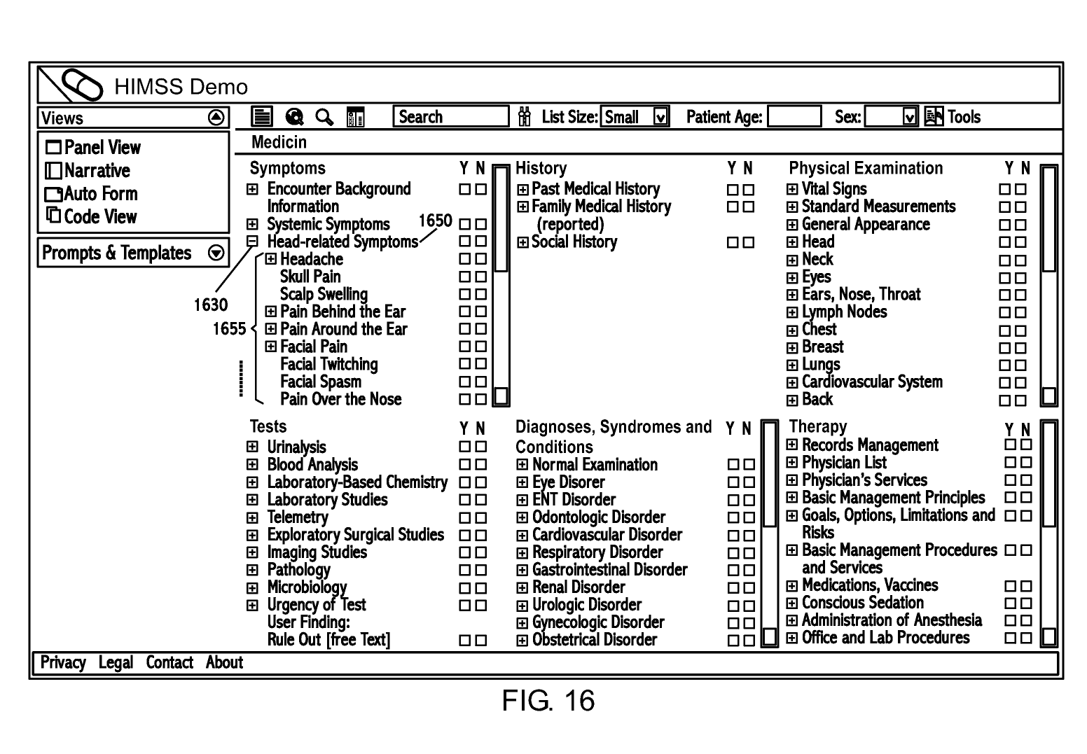

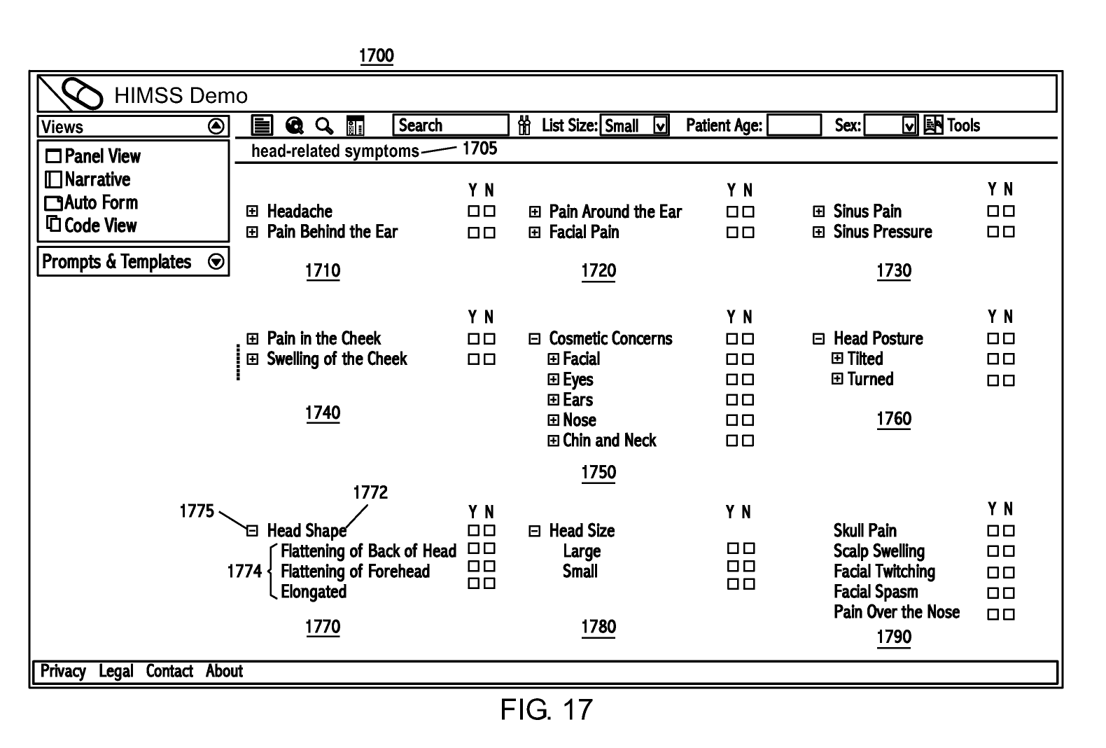

Further down in the hierarchical database can be child data elements 1520. Note that in this example, each child data element 1520 has plus block 1530 beside it. Each of the plus blocks 1530 indicates that there are additional data elements, i.e., a grand-child, below each of the child data elements 1520 having an associated plus block 1530. Since this is an exemplary view of very high levels of the data in the hierarchical database, most of the child data elements 1520 will have the plus block 1530. Of course, the opposite of a plus block can be a minus block or no block, both of which will be discussed later with reference to FIGS. 16 and 17, respectively.

In the exemplary display as shown in FIG. 15, the data element or information can be displayed in multiple frames or boxes, indicated by data elements 1510 on the screen by one of the following two methods: an attribute method and a division method.

In the attribute method, each data element 1510 and child data element 1520 can be assigned one of several attribute codes when the database is created appropriate to the kind of information represented by the particular data element 1510 or child data element 1520. Then, when it is desired to display the information, the data elements 1510, child data elements 1520, and so on in the hierarchy, can be distributed to the frames using the attribute codes. Each data element can thus be displayed in a frame containing similar kinds of information. Since the information may now be of a similar kind, the next level down may also be displayed, appropriately indented. This means that in addition to being categorized, two levels of each kind of information can be displayed at once, thus greatly reducing the number of clicks for the viewer to find the desired information.

In the division method, the information can be distributed equally by simple division to the desired number of frames. A third second level may be displayed, such as shown in FIG. 17, appropriately indented, depending on the size of the hierarchy. This second method would be appropriate where the kinds of information vary too widely for categorization to be useful or where the information is all of one type.

As shown in FIG. 15, there can be six boxes or frames, each with data elements 1510 according to an attribute of finding type: Symptoms, History, Physical Examination findings, Tests, Diagnoses and Therapy. The attribute, for example, can be a letter, such as S, H, P, T, D and Rx, a number, symbol or any combination thereof.

Still referring to FIG. 15, if a user were to select the plus block 1530 beside data element 1550 “Head-related Symptoms,” it could expand to expose grand-child data elements as shown in FIG. 16.

FIG. 16 illustrates an example of an expanded view of a child data element 1650. By the user selecting the plus block 1530 beside data element 1550 “Head-related Symptoms,” it can change to a minus block 1630, exposing grand-child data elements 1655.

However, returning to FIG. 15, in this example if a user were to double-click on the text of the child data element 1550 “Head-related Symptoms,” the next level of data elements (grand-child data elements) can be displayed in nine frames, in this case, distributed by simple division. This is an example of the Division method of expanding the data and is illustrated in FIG. 17. FIG. 17 illustrates an example of data view 1700 comprising main data element 1705 “head-related symptoms,” and nine frames 1710-1790.

Frame 1770 provides an example of a minus block 1775. In this frame view, not only can the grand-child data element 1772 “Head Shape” be shown to the user, but also great-grand-child data elements 1774. Frame 1760 provides a similar view.

Frame 1790 illustrates an example of no plus or minus blocks. The data elements in the lower right frames can be configured to be allocated the lowest level data in the hierarchical database for the selected child data element, which in this example was element 1650 of FIG. 16.

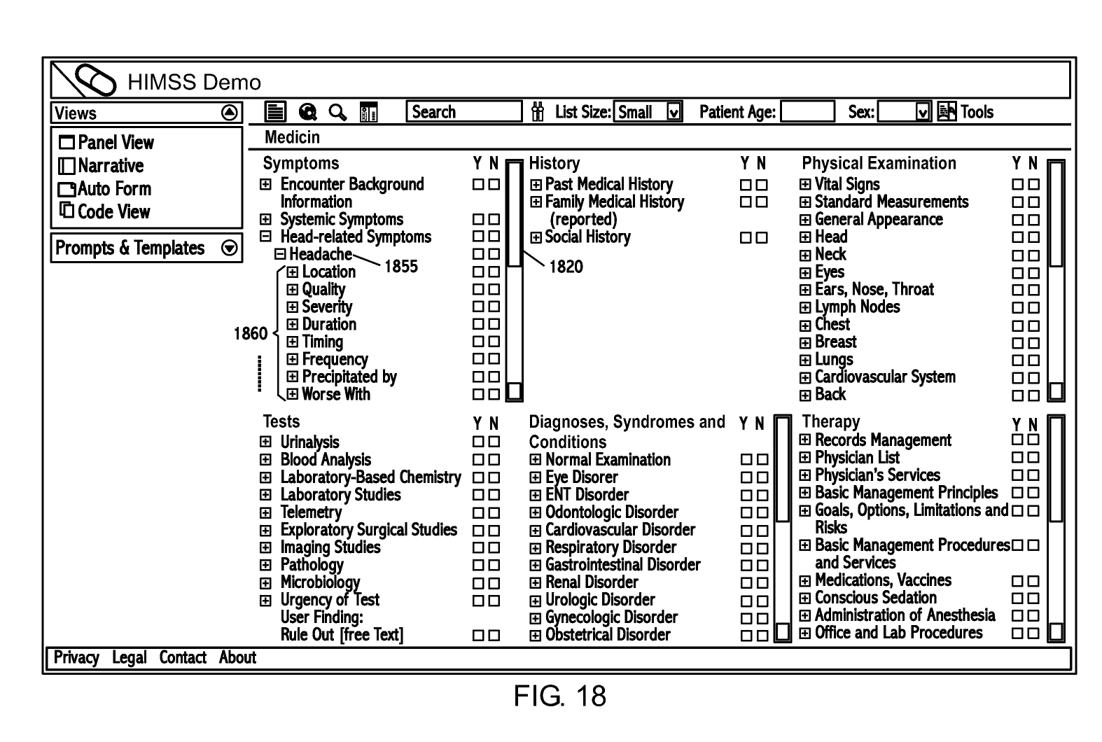

FIG. 18 illustrates an example of the expansion of child data element 1550 to reveal grand-child data element 1855 “Headache,” which has great-grand-children data elements 1860, e.g., location, quality, severity, duration and so on. In this example, other great-grand-children data elements 1860 could be viewable by pulling down slide bar 1820. The slide bar 1820 can be displayed when the number of data elements to be displayed is greater than the size of the frame. The number of data elements can be determined by the attributes assigned to each data element.

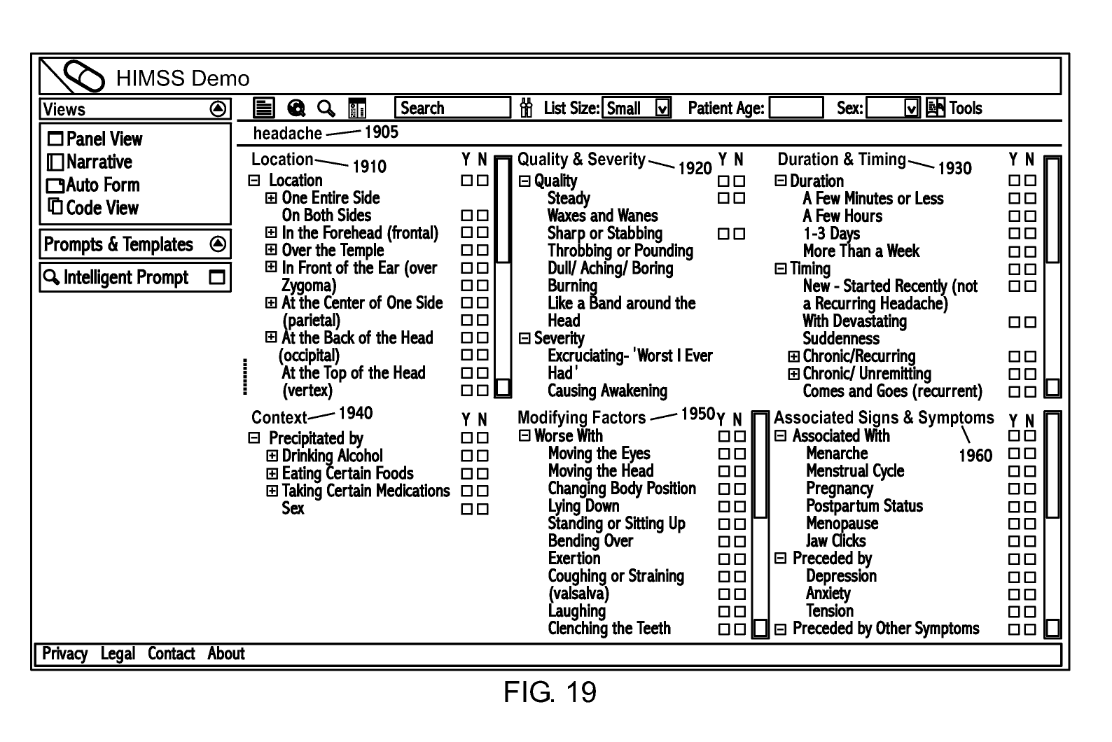

However, if a user were to double-click on data element 1855 “Headache” in this example, the resulting display could look like FIG. 19. In the example shown in FIG. 19, the main data element is 1905 “headache,” and the next level of data elements, “location” 1910, “quality & severity” 1920, “duration & timing” 1930, “context” 1940, “modifying factors” 1950 and a catch-all “associated signs & symptoms” 1960, are distributed based on attributes assigned to each of the data elements into six frames. The names corresponding to each of the attributes can be at the top of each frame. Note that in some cases, two attributes are being shown in a single frame, such as Quality and Severity, or Duration and Timing.

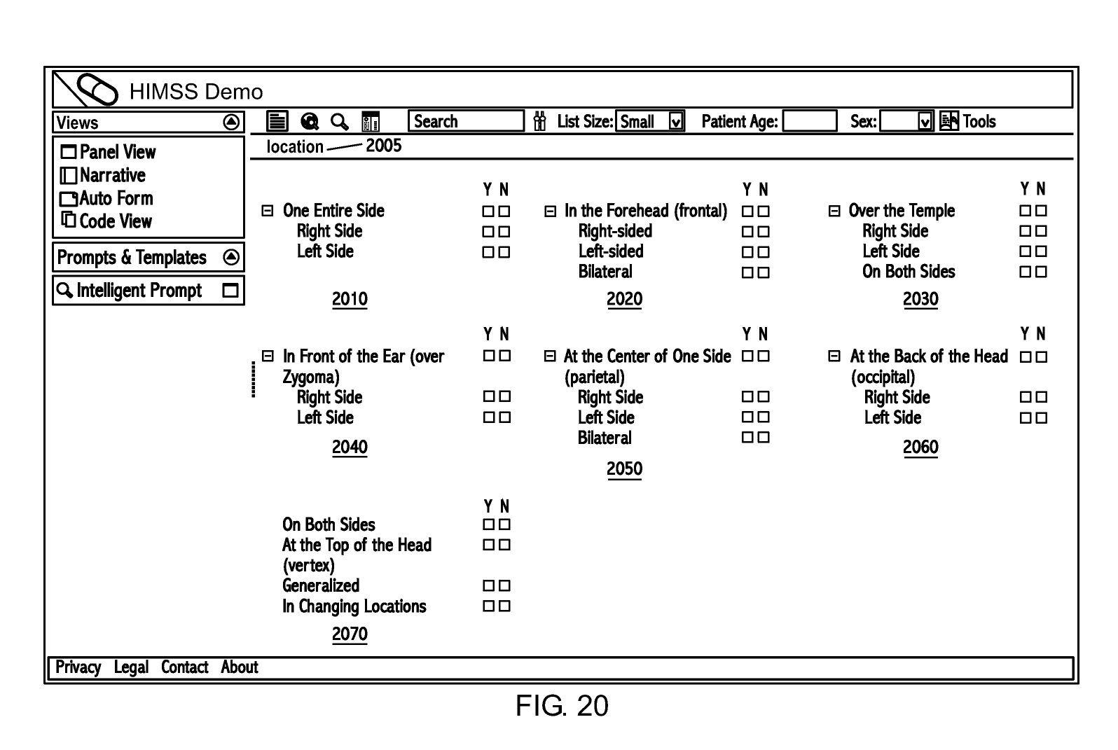

Referring to FIGS. 19 and 20, to view even lower levels of the hierarchy, if the user were to double-click the data element “location” 1910, a new widow could appear with the main data element 2005 being entitled “location,” and each frame 2010-2070 could list the information represented by data elements beneath headache location in the hierarchical database.

FIG. 21 illustrates an exemplary system for implementing an embodiment of the above described method. The system 2100 can include a central processing unit (CPU) 2110, a network 2120, a storage device 2130 for storing a database 2135 with data arranged, for example, in a hierarchy, a display device 2140 and an input device 2150.

The central processing unit 2110 can be, for example, one of a plurality of personal computers, which can be connected to network 2120. In addition, the central processing unit 2120 can be operatively connected to the input device 2150 for entering data received from a patient into a processor via a web browser application or the like, where the web browser can be configured to generate a form populated with the data entered using the input device. The placement of the data on the form can be based on the hierarchy of the data received from the patient. The input device 2150 can be, for example, a mouse, stylus, keyboard, voice command device or similar device. The input device may be connected via a wired or wireless network connection, as may be the other devices in the network.

The system can include an electronic mail application and an output device such as a facsimile device, display device 2140, printer, other output device, or any combination thereof. The network 2120 can be an intranet or the Internet, and can be connected to server 2115 and can transmit and receive data via the web browser or electronic mail application or other form of communication application. The display device 2140 can be a computer monitor having a display 2140A.

The display 2140A can present data, for example, in a plurality of frames 2141-2149 by using an exemplary embodiment of the disclosed method discussed above.

The server 2115 can contain software that that is downloadable to the CPU 2110. The software can be used by the web browser. The connection between CPU 2110 and server 2115 may last as long as it takes to download instructions for executing an exemplary embodiment of the disclosed method. The downloaded instructions can be executed by the CPU 2110. This can free the server to connect with other users, such as 2111 and 2112. The server 2115 can store the instructions executed by the CPU 2110 on computer readable storage devices. Examples of computer readable storage devices include RAID arrays, compact discs, hard drives, flash memory, digital versatile discs, random access memory, and the like.

The mapping of the frames and the related data in the web browser can be accomplished using a variety of languages, such as, for example, mark-up languages XML, AJAX, Java, JavaScript or a combination thereof. The size of the frames within the browser window as shown in FIG. 15, for example, can be of any size or number as determined by the designer. For example, XML commands for mapping the data elements to a particular frame or other part of the display can be embedded with the data information being retrieved from the server 2115 by the user's web browser. A suitable web browser can be, for example, Microsoft Internet Explorer 7.0 or other web browser having similar functionality and capabilities as Microsoft Internet Explorer 7.0. In addition, exemplary embodiments can take advantage of Web 2.0 concepts.

In an exemplary system and method for automatically generating forms, selected data from a hierarchical database, such as medical findings of symptoms, physical findings, and the like, can be used to generate a form dynamically. The placement of the information on the form can be determined based on the hierarchy of the data in the database.

As noted above, the data elements and sub-elements can be in a parent-child relationship and each data element and child data element can be assigned one of several attribute codes when the database is created appropriate to the kind of information represented by the particular data element or child data element. Then, when it is desired to display the information, the data elements, child data elements and so on in the hierarchy may be distributed to the frames using the attribute codes. Each data element may thus be displayed in a frame containing similar kinds of information.

In one embodiment, a user can select any combination of the following exemplary or similar data sources:
Medical findings from a database;
Previously built lists of findings;
Findings prompted by an Intelligent Prompt routine; and
Existing auto-generated forms.

A Forms Auto-Generator can merge the findings from the above various exemplary sources or other sources, and sort them according to a medical database hierarchy. Duplicate findings can be eliminated during form generation by known methods.

The Auto-Generator can optionally separate the symptoms, physical exam findings, tests, and other data onto separate pages or tabs on the generated form by using the data hierarchy or other means, such as the attributes of the findings or data.

In one embodiment, the generated form can be configured to be filled out while still viewable in the web browser and stored or forwarded to another user. In another embodiment, the generated form can be configured to be forwarded to another user to fill out and return. In another embodiment, the user can be a patient and the form can be configured to be filled out and returned before a scheduled visit or as a periodic record update of information needed by a physician in managing the patient's condition. In another embodiment, the generated form can be used to select certain information from a patient's record for forwarding to another physician.

The above description is presented to enable a person skilled in the art to make and use the systems and methods described herein, and is provided in the context of a particular application and its requirements. Various modifications to the embodiments will be readily apparent to those skilled in the art, and the generic principles defined herein may be applied to other embodiments and applications without departing from the spirit and scope of the claims. Thus, there is no intention to be limited to the embodiments shown, but rather to be accorded the widest scope consistent with the principles and features disclosed herein.

What is claimed is:

1. A method of generating forms based on a hierarchy of data received from a patient, comprising:
entering data received from a patient into a processor via an input device;
generating a form populated with the entered data, wherein the placement of the data on the form is based on a hierarchy of the data received from the patient;
receiving and transmitting the data and generated form via a web browser or an electronic mail application using a network connection;
storing the data and generated form; and
outputting the generated form or received data.

2. A system for generating forms based on a hierarchy of data received from a patient, comprising:
an input device for entering data received from a patient into a processor;
a web browser, wherein the web browser is configured to generate a form populated with the data entered using the input device, and wherein the placement of the data on the form is based on a hierarchy of the data received from the patient;
a network connection for receiving and transmitting the data and the generated form via the web browser or an electronic mail application;
a memory for storing the data and forms generated by the web browser; and
an output device for outputting the generated form or the data.

3. The system of claim 2, wherein the generated form is configured to be filled out while still viewable in the web browser and stored or forwarded to another user.

4. The system of claim 2, wherein the generated form is configured to be forwarded to another user to fill out and return.

5. The system of claim 4, wherein the user is a patient and the form is configured to be filled out and returned before a scheduled visit or as a periodic record update of information needed by a physician in managing the patient's condition.

6. The system of claim 2, wherein the generated form is used to select certain information from a patient's chart for forwarding to another physician.

7. A computer-readable medium containing instructions for causing a computer to execute a method of generating forms based on a hierarchy of data received from a patient, comprising:
entering data received from a patient into a processor via an input device;
generating a form populated with the entered data, wherein the placement of the data on the form is based on a hierarchy of the data received from the patient;
receiving and transmitting the data and generated form via a web browser or an electronic mail application using a network connection;
storing the data and generated form; and
outputting the generated form or received data.
